(19) United States
(12) Patent Application Publication
(10) Pub. No.: US 2004/0045941 A1
(43) Pub. Date: Mar. 11, 2004

(54) Device for sintering, removing material and/or labeling by means of electromagnetically bundled radiation

(76) Inventors: Frank Herzog, Lichtenfels (DE); Kerstin Herzog, Lichtenfels (DE)

Correspondence Address: MERCHANT & GOULD PC, P.O. BOX 2903, MINNEAPOLIS, MN, 55402-0903, US

(21) Appl. No.: 10/415,391

(22) PCT Filed: Oct. 30, 2001
(86) PCT No.: PCT/DE01/04056

(30) Foreign Application Priority Data
Oct. 30, 2000 (DE) 10053741.3

(51) Int. Cl. B23K 26/00

(52) U.S. Cl. 219/121.6

(57) ABSTRACT

The invention relates to a device for sintering, removing material and/or labeling by means of electromagnetically bundled radiation, especially to a laser sintering machine and/or a laser surface-processing machine. Said device comprises a construction space (3) which is accommodated in a machine housing (2) and in or above which the following are located: a light-guiding device, especially a scanner (4), into which the beam of a sintering energy source is coupled; a vertically displaceable workpiece platform (7); and a material supply device comprising a coater (9) for supplying sintering material from a supply container (8) to the process area above the workpiece platform (7). Said workpiece platform (7) is a changeable element which can be removed from the construction space (3). The vertically displaceable workpiece platform (7), the supply container (8) and the coater (9) are configured in such a way that they can be removed together from the construction space (3) in the form of a changeable process platform unit (10). Other changeable process platform units (10) with the same or different configurations can be introduced into the construction space (3) in order to carry out the same or different processing operations.

The invention relates to a device for sintering, removing material and/or labeling by means of electromagnetically bundled radiation, especially a laser sintering machine and/or laser surface-processing machine having the additional features of the precharacterizing clause of claim 1.

Known from DE 198 46 478 is a laser sintering machine where a construction space is accommodated in a machine housing in whose top area is located a scanner into which the beam of the sintering laser is coupled. Arranged under the scanner is a vertically displaceable working material platform, in the vicinity of which is provided a material-supplying device with a coater serving for supplying powder, paste or liquid sintering material from a supply container into the processing area above the working material platform. The work piece platform is removable from the construction space as a changeable element. Only sintering processes can be carried out with this device. Besides, after preparing a work piece, the non-sintered, loose powder must be returned to the supply chamber manually, using a sieve. Before producing a work piece with another sintering material, the supply container as well as the coater must be cleaned, which considerably lengthens the down times between two construction operations.

The object of the invention is to develop a device with the further features of patent claim 1, such that with it the down times between two construction processes are considerably shortened, and the device is more flexibly usable. This objective is met by the entire teaching of claim 1. Advantageous further configurations are obtained from the subclaims 2-26.

As core of the invention, first to be seen is that the vertically displaceable work piece platform, the supply container and the coater are constructed to be removed from the construction space as one process platform/changeable unit and, for carrying out similar or other processing operations, capable of being placed in the construction space are other process platform/changeable units of the same or similar configurations, e.g. without supply container and coater. Accordingly, the laser, with the optical components coupled to it, is appropriately separated from the work piece to be processed, or to be precise, from the required sintering material. Therefore, it is possible, immediately after ending a sintering process or some other work piece operation, to carry out the next processing operation merely by changing out the process platform/changeable units. The completely separate units additionally have the advantage that the laser is usable for different operations. Moreover, in the event of a damaged component in the area of the work piece to be processed, e.g. in the case of a defective coater, the laser machine can continue to be used without considerable down times. The entire device in accordance with the invention is, accordingly, usable in extremely flexible fashion, whereby between two processing operations only extremely short down times occur for changing out the replaceable units, and therewith the processing laser is better used to capacity.

Another process platform/changeable unit of a different construction can display a table-like clamping surface and therewith co-operating clamping elements for work pieces. The clamping surface is located on the work piece platform. This platform is, for example, suitable for labeling, ablation, welding or for distance measurement with the laser. The work piece platform or rather the clamping surface integrated into the changeable unit can in practice be constructed to be vertically displaceable, in order, e.g. to be able to set exactly the required distance to the scanner. In practice, however, the scanner is also appropriately displaceable in all directions, thus also in the vertical direction.

In advantageous further development, this additional process platform unit and/or the integrated work piece platform can be automatically rotatable about at least one vertical axis and/or pivotable about horizontal axes. This enables an extremely flexible processing of the work piece located on the work piece platform whereby, in particular, its edge surfaces, beveled surfaces or undercuts can be processed in simple fashion, with uniform quality, with the laser beam impinging thereupon. The rotatability and tiltability about the horizontal and/or the vertical axes can be accomplished by motorized drives that are in practice controlled by a process computer of the device. Thus an exact as well as a rapid and reproducible setting of an optimal position of the work piece platform is possible.

Limit (stop) elements can be provided in the construction space in order to be able to bring different process platform/changeable units into defined processing positions within definite, minimum bounds. In one particularly advantageous variant of embodiment the process platform/changeable units can display a coding that can be recognized by the laser elements of the device, so that an exact, automatically executable positioning of the process platforms is possible. Furthermore, because of the coding, it is possible for the device's process computer to select processing programs such as, e.g. sintering/fusing and/or labeling, ablation, welding, distance measuring and the like. In this way e.g. it is possible also to automatically set the radiation energy and focusing of the laser beam for the particular process.

The process platform/changeable units can in practice be made lockable in their processing position in the construction space with locking elements. To automatically line up the process platform/changeable units in a processing position, the locking elements can be motor driven.

To be able to execute a rapid and simple change out of the process platform/changeable units, the changeable units can be constructed as rolling modules provided with castors and capable of being placed into the construction space. To obtain a stable unit, the process platform/changeable units can display a box-like housing that simultaneously represents a protective jacket against external influences (e.g. against contamination or mechanical effects). Also capable of being arranged inside the box-like housing are motorized drives for changing the position or location of the work piece platform.

To guarantee optimal processing of the work pieces, it is possible, when bringing the process platform/changeable units into the construction space, to automatically produce electrical connections and/or (fluid) flow channel connections between the device and the changeable unit. The laser device and the processing device thus operate together as a unit. The flow channels serve for aeration with inert gas in the construction space to prevent oxidation of the work piece or of the working substance during the laser processing. In his case, the flow channels are preferably arranged such that there is produced in the construction space a defined laminar flow by injection and removal with inert gas, e.g. argon. Particularly advantageously, the inert gas that has already flowed through the construction space can be processed and re-supplied to the construction space. Capable of being arranged in or at the end of the flow channels are filters that clean the gas flowing through.

Additionally, each process platform/changeable unit can display a separate process contrivance, whereby there occurs a transfer of data to the laser device via a data transfer means located in the construction space. The guidance of the laser as well as the movement of the process platform can, therewith, be optimally synchronized to each other, so that exact laser beam guidance can be executed. The data transfer means can be constructed as optical interfaces and are, therefore, in great measure independent of contamination in the form of sintering material. Besides this contactless data transfer means, these means can additionally or alternatively display plug contacts.

Particularly advantageously, a position recognition device for the process platform/changeable units can be arranged in the construction space, whereby any platform positions or locations from the process computer of the device can be recognized and be taken into account at the time of run off of the applicable process technology.

Furthermore, the clamping elements can also be associated with a manipulator that can be controlled via the process computer and, therewith, hold the work piece in exactly the desired position.

Advantageously, the position of the clamped work piece can be automatically recognized. In this way, an exact processing of the work piece can be excecuted without having to position it precisely manually beforehand.

In one special form of embodiment, a removal device for loose and/or non-sintered powder in the vicinity of the work piece platform can be arranged on the process platform/changeable unit. In practice, the removal device can be integrated in the process platform/changeable unit. This automatic elimination of the excess powder can reliably prevent the machine user from coming into contact with the powder.

The removal device can advantageously be provided in the lower part of the process platform/changeable unit, since the work piece platform, after the construction process, is driven downwardly and the non-sintered powder can be removed there.

The removal device can include an evacuation device that is disposed in the lower part of the vertically displaceable work piece platform and, there, the loose powder is in great part evacuated. A conveying contrivance for transport of the powder into the supply container can be connected to the evacuation device. The conveying contrivance can here be constructed, for example, as a worm drive. In this method of returning the powder into the supply container, reliably prevented for one thing is that the powder become contaminated. The automatic return transport of the powder, for another thing, represents a special timesaving process step that replaces the extremely inconvenient, manual shoveling out of the powder.

The invention is explained in more detail with the aid of advantageous examples of embodiment in the sketches.

They show:

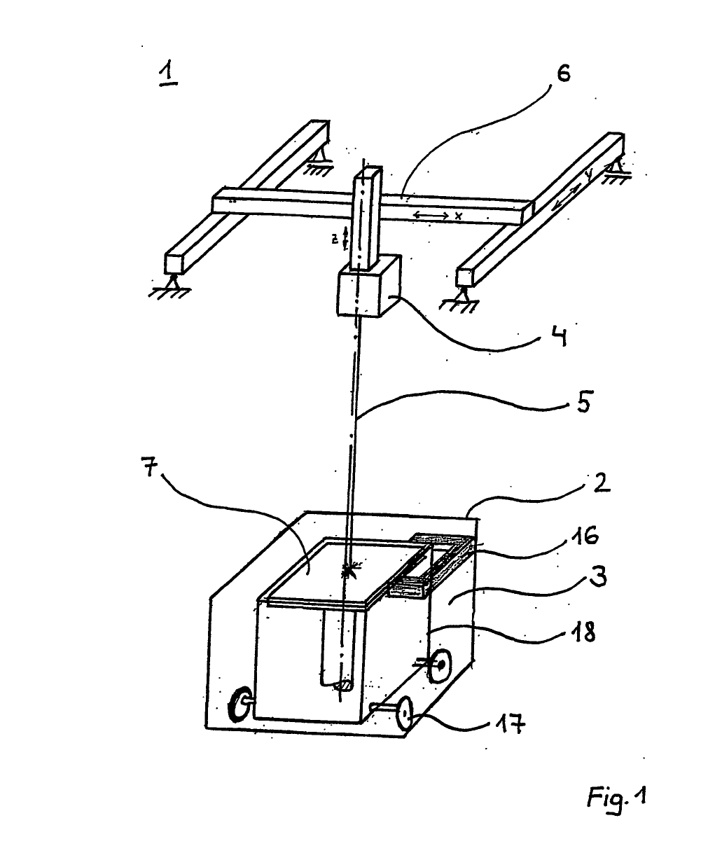

FIG. 1 a greatly simplified perspective representation of the device in accordance with the invention;

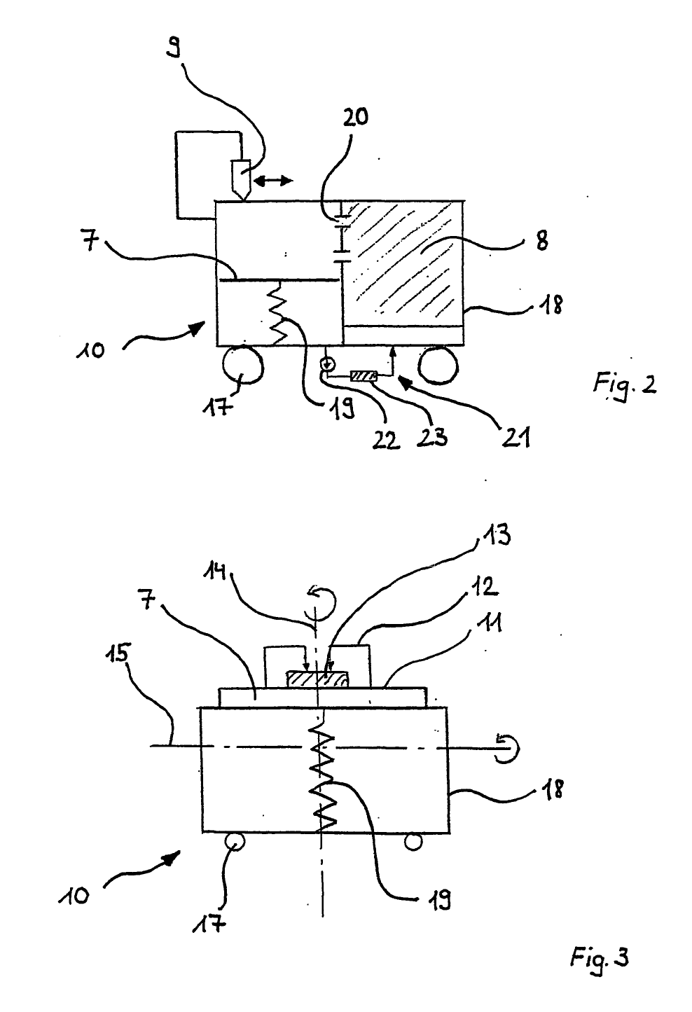

FIG. 2 a section through a simplified perspective representation of the device in a side view in accordance with the invention, and

FIG. 3 a section through a simplified representation of another process platform/changeable unit in a side view.

Reference number 1 designates overall the device for sintering, ablation and/or labeling by means of electromagnetically bundled radiation. In the case of device 1 we are dealing with a laser sintering and surface processing machine, with a construction space 3 accommodated in a machine housing 2 above which is disposed a scanner 4, into which is coupled the beam of a sintering source of energy. The laser beam coming out from the scanner 4 is given the reference number 5. The scanner 4 is displaceable in all directions via a cross slide support 6. Located in the construction space 3 for carrying out stereographic construction procedures is a vertically displaceable work piece platform 7, a supply container 8 and a coater 9, which are constructed as a process platform/changeable unit 10 capable of being removed from the construction space 3 as a connected unit. For carrying out like or other processing operations, other process platform/changeable units 10 of the same or different designs can be brought into the construction space 3, e.g. as can be seen in FIG. 3. Obtained with the process platform/changeable units 10 is a separation of the laser, or to be precise, optical components as well as the components to be processed, so that the device 1 is for one thing more flexibly usable, and for another thing the down times between the individual processing operations, e.g. because of cleaning measures or cooling procedures, are considerably reduced.

The process platform/changeable unit 10 in accordance with FIG. 2 essentially serves for carrying out the stereographic construction procedures. According to the sketch, the work piece platform 7 is vertically displaceable by means of a scissors jack 18.

The other process platform/changeable unit 10 in accordance with FIG. 3 displays a table-like clamping surface 11 and therewith cooperating clamping elements 12, with which the work piece to be processed can be positioned and held securely, especially during the processing operation. The work material platform 7 in the case of this changeable unit 10 is likewise constructed to be vertically displaceable by means of a scissors jack 18. Besides the scissors jack 18, there naturally exist other possibilities for vertical displacement, as e.g. a hydraulic or pneumatic drive unit. The process platform/changeable unit 10 is also automatically rotatable about a perpendicular axis 14, whereby the scanner 4 and the work piece 13 can execute an increased number of motions relative to each other, and an optimal processing of the work piece 13 will be guaranteed. The other process platform/changeable unit 10 can also be tiltable about horizontal axes, of which a horizontal axis 15 is sketched in, for example in FIG. 3. Besides, there also exists the possibility that the process platform/changeable unit 10 can be tiltable about diagonal axes. tiltable about diagonal axes. Tiltability of the process platform/changeable unit 10 and/or the work piece platform 7 guarantees an optimal processing, e.g. of beveled surfaces or undercuts on work piece 13. Rotatability and tiltability about the horizontal axis 15 and/or the vertical axis 14 is accomplished by (not represented in more detail in the sketches) motorized drives that are controlled by a process computer of device 1, in order to bring about an exact setting (adjustment) of the process platform/changeable unit 10 or the work piece 7.

As can be recognized in FIG. 1, provided in the construction space 3 are stop elements 16 in order to be able to bring different process platform/changeable units 10 into defined process positions.

Furthermore, each process platform/changeable unit 10 displays coding that is recognized by the laser elements of device 1. Because of the coding, the process computer of the device 1 can select different process programs, such as e.g. sintering/fusing and/or labeling, welding, measuring distance, etc. Accordingly, processing of the work piece 13 can occur immediately after setting in the changeable unit 10, without needing to program the process computer beforehand.

In order to stay in the set position during the processing operation, the process platform/changeable unit 10 can be locked in the construction space 3 with stop elements. The stop elements here are motor driven in order to automatically adjust the process platform/changeable unit 10 in a processing operation position. However, the stop elements are not represented in more detail in the sketch.

To guarantee a rapid and simple change out of the process platform/changeable units 10, they are constructed as rolling modules equipped with castors 17 capable of being placed into the construction space 3.

The process platform/changeable units 10 display box-like housings 18 in which are arranged the scissors jacks 19 as well as motorized drives for resetting the position or location of the process platform/changeable units 10 and/or the work piece plates 7.

When bringing the process platform/changeable units 10 into the construction space 3, electrical connections and/or flow channel connections are automatically provided between the device 1 and the process platform/changeable unit 10. Additionally, each process platform/changeable unit 10 displays a separate processor device, whereby there follows a transfer of data over data transfer means disposed in the construction space 3. The data transfer means can, for example, be constructed as optical interfaces that are, in particular, relatively insensitive to contamination. Additionally arranged in the construction space 3 is a location recognition device for the process platform/changeable units 10. With this any process platform locations or positions are recognized by the process computer of device 1, and are taken into account when running off the particular process technology. The flow channels 20 serve for conducting inert gas (e.g. argon) into the construction space 3, where expended gas is processed, e.g. via filters and re-supplied to the construction space 3. The flow channels 20 for inert gas conduction and recovery are represented in the sketches in accordance with FIG. 2 only in the changeable unit 10. Naturally, it is also possible that the flow channels 20 also be integrated in the process platform/changeable unit 10 in accordance with FIG. 3, with which the work pieces 13 have material removed and are labeled. Additionally, it is then advantageous to close off to the outside the construction space 3 in which the work piece is located.

Besides this, the clamping elements 12 are disposed on a manipulator that can be controlled via the process computer, and that brings the clamped work piece 13 into the optimal processing position and holds it there during the processing operation. Moreover, the location of the clamped work piece 13 can be automatically recognized (e.g. by the location recognition device), so that an exact processing is possible without expensive positioning measures.

The process platform/changeable unit 10 in accordance with FIG. 2 further displays a removal device 21 for loose and/or non-sintered powder that falls in the area of the work piece platform 7. The removal device 21 is provided in the lower region of the process platform/changeable unit 10. After ending the construction process of the sinter work piece, the work piece platform 7 moves downward. There, the loose and/or incompletely sintered powder is suctioned off by the suctioning device 22, to the removal device 21. Connected to the suctioning device 22 is a conveying contrivance 23 that transports the powder into the supply container 8. An automatic powder return that is extremely time saving is thereby obtained, and the returned powder is protected against contamination.

1. Device for sintering, ablation and/or labeling by means of electromagnetically bundled radiation, especially laser sintering machines and/or laser surface processing machines, with a construction space (3) accommodated in a machine housing (2), in or above which are arranged a light-conducting device, in particular a scanner (4) into which is coupled the beam of a sinter energy source, a vertically displaceable work piece platform (7) and a material-supplying device with a coater (9) serving for feeding sintering material from a supply container (8) into the process area over the work piece platform (7), whereby the work piece platform (7) is removable from the construction space (3) as a changeable element, characterized in that the vertically displaceable work piece platform (7), the supply container (8) and the coater (9) are constructed as process platform/changeable units (10) capable of being removed, while remaining connected together, from the construction space (3), and that other process platform/changeable units (10) of the same or different design can be brought into the construction space (3) for carrying out similar or other processing operations.

2. Device according to claim 1 characterized in that another process platform/changeable unit (10) of different design displays a table-like clamping surface (11) and clamping elements for work pieces (13) that work together with the clamping surface.

3. Device according to one of the foregoing claims characterized in that the work piece platform (7), the process platform/changeable unit (10) or the clamping surface (11) is constructed to be vertically displaceable.

4. Device according to one of the foregoing claims characterized in that another process platform/changeable unit (10), work piece platform (7) or clamping surface (11) is automatically rotatable about at least one vertical axis (14).

5. Device according to one of the foregoing claims characterized in that another platform/changeable unit (10), work piece platform (7) or clamping surface (11) is tiltable about horizontal axes (15).

6. Device according to one of the foregoing claims characterized in that the rotatability and/or the tiltability about the horizontal axes (15) is accomplished by motorized drives.

7. Device according to claim 6 characterized in that motorized drives are controlled by a process computer of the device (1).

8. Device according to one of the foregoing claims characterized in that stop elements (16) are provided in the construction space in order to be able to bring different process platform/changeable units (10) into defined process positions.

9. Device according to one of the foregoing claims characterized in that each process platform/changeable unit (10) displays a coding that can be recognized by reading elements of the device (1).

10. Device according to claim 9 characterized in that because of the coding of the process computer of device (1), different process programs (sintering, fusing, and/or labeling, ablation, welding, measuring of distance) can be selected.

11. Device according to one of the foregoing claims characterized in that the process platform/changeable units (10) can be locked with stop elements in their operating position in the construction space (3).

12. Device according to claim 11 characterized in that the stop elements can be motor driven in order to automatically adjust the process platform/changeable units (10) in their processing position.

13. Device according to one of the foregoing claims characterized in that the process platform/changeable units (10) are constructed as rolling modules equipped with castors 17 that can be placed into the construction space (3).

14. Device according to one of the foregoing claims characterized in that the process platform/changeable units (10) display a box-like housing (18).

15. Device according to one of the foregoing claims characterized in that motorized drives for resetting the position or location of the process platform/changeable units (10) are disposed in the box-like housing (18).

16. Device according to one of the foregoing claims characterized in that when bringing the process platform/changeable units (10) into the construction space (3), electrical connections and/or flow channels (20) are automatically produced between the device (1) and the process platform/changeable units (10).

17. Device according to one of the foregoing claims characterized in that each process platform/changeable unit (10) displays a separate processor device, and a transfer of data is effected via data transfer means arranged in the construction space (3).

18. Device according to claim 17 characterized in that the data transfer means are constructed as optical interfaces.

19. Device according to one of the claims 17 or 18 characterized in that the data transfer means display plug contacts.

20. Device according to one of the foregoing claims characterized in that the location of the clamped work piece (13) can be automatically recognized.

21. Device according to one of the foregoing claims characterized in that disposed in the construction space (3) is a location recognition device for the process platform/changeable units (10), and any process platform locations or positions can be recognized by the process computer of the device (1), and when running off the particular process technology (sintering/fusing, and/or labeling, ablation, welding, measuring distance) will be taken into account.

22. Device according to one of the foregoing claims characterized in that the clamping elements (12) are arranged on a manipulator that can be controlled by the process computer.

23. Device according to one of the foregoing claims characterized in that disposed on the process platform/changeable unit (10) is a removal device (21) for loose and/or incompletely sintered powder in the vicinity of the work piece platform (7).

24. Device according to claim 23 characterized in that the removal device (21) is provided in the lower part of the process platform/changeable unit (10).

25. Device according to one of the claims 23 or 24 characterized in that the removal device (21) includes a suctioning device (22).

26. Device according to one of the claims 23-25 characterized in that the removal device (21) includes a conveying device (23) for transport of the powder into the supply container (8).
